(19) United States
(12) Patent Application Publication
(10) Pub. No.: US 2024/0419515 A1
(43) Pub. Date: Dec. 19, 2024

(54) DATA PROCESSING METHOD AND APPARATUS, AND STORAGE MEDIUM

(71) Applicant: Beijing Zitiao Network Technology Co., Ltd., Beijing (CN)

(72) Inventors: Xing Shi, Beijing (CN); Shu Wang, Beijing (CN); Yuqi Shen, Beijing (CN); Junli Xian, Beijing (CN)

(21) Appl. No.: 18/817,117

(22) Filed: Aug. 27, 2024

(30) Foreign Application Priority Data
Aug. 28, 2023 (CN) 202311092300.2

(51) Int. Cl. G06F 9/54

(52) U.S. Cl. CPC G06F 9/542; G06F 2209/541

(57) ABSTRACT

The present application provides a data processing method and apparatus, and a storage medium. Specifically, after target request data to be processed is acquired, a first example set may be determined from a preset example library according to the target request data. The first example set includes a plurality of pieces of first example data, and the first example data may provide a reference when the target request data is processed. Next, prompt information may be sent to a target model. The prompt information includes the target request data and the first example set. The target model may learn the first example set and process the target request data after learning the first example set. After completing processing the target request data, the target model may return an output result obtained based on the prompt information.

### CROSS-REFERENCE TO RELATED APPLICATION(S)

This application claims priority to Chinese Application No. 202311092300.2 filed Aug. 28, 2023, the disclosure of which is incorporated herein by reference in its entity.

### FIELD

The present application relates to the technical field of computers, and in particular to a data processing method, apparatus and system, a file sending method, apparatus and system, and a storage medium.

### BACKGROUND

With the development of computer technologies, it is a common technical means to process data via a model. The efficiency and accuracy of data processing can be improved by processing the data via the model.

In some application scenarios in which the data is processed by the model, a reference may be provided for a model by example data. For example, the model may perform learning according to the example data, and then process data to be processed after learning. In this way, by learning the example data, the data can be better processed according to a corresponding rule. Moreover, there is no need to train the model when the model learns the example data.

In a scenario in which data processing is assisted by the example data, the quality of the example data affects the quality of data processing.

### SUMMARY

In order to solve the problems in the prior art, the present application provides a data processing method, apparatus and system, and a storage medium.

In a first aspect, the present application provides a data processing method, including:
acquiring target request data;
determining a first example set from a preset example library according to the target request data, wherein the first example set includes a plurality of pieces of first example data;
sending prompt information to a target model, wherein the prompt information includes the target request data and the first example set; and
receiving an output result returned by the target model based on the prompt information.

In some possible implementations, the method further includes:
acquiring a second example set, wherein the second example set includes a plurality of pieces of predetermined second example data;
wherein the prompt information further includes the second example set.

In some possible implementations, the first example set is in front of the second example set in the prompt information.

In some possible implementations, the plurality of pieces of predetermined second example data are used for enumerating a plurality of expressions of a preset field in an example.

In some possible implementations, determining the first example set according to the target request data includes:
separately calculating a similarity between each piece of candidate example data in the example library and the target request data; and
determining a plurality of pieces of first example data from the example library according to the similarity.

In some possible implementations, the candidate example data includes candidate request example data and candidate request result data, and the candidate request result data corresponds to target result data; and
separately calculating the similarity between each piece of candidate example data and the target request data includes:
calculating a similarity between the candidate request example data and the target request data.

In some possible implementations, the plurality of pieces of candidate example data include a first candidate data group, the first candidate example data includes first candidate request example data, and calculating the similarity between the candidate request example data and the target request data includes:
determining a first vector according to the target request data;
determining a second vector according to the first candidate request example data; and
determining a similarity between the target request data and the first candidate request example data according to the first vector and the second vector.

In some possible implementations, determining the first vector according to the target request data includes:
filtering the target request data by a filtering model to obtain a first word set; and
determining the first vector according to the first word set.

In some possible implementations, the target request data is request data in a target task scenario, and the first example data includes example data in the target task scenario.

In some possible implementations, the target task scenario is a search task scenario, the first example data includes unstructured data and structured data, the target request data is unstructured data, and the output result is structured data; and
the method further includes:
sending the output result to a search service, and receiving a search result returned by the search service.

In a second aspect, the present application provides a data processing apparatus, including: an acquisition unit, configured to acquire target request data; a determination unit, configured to determine a first example set from a preset example library according to the target request data, wherein the first example set includes a plurality of pieces of first example data; a sending unit, configured to send prompt information to a target model, wherein the prompt information includes the target request data and the first example set; and a receiving unit, configured to receive an output result returned by the target model based on the prompt information.

In some possible implementations, the acquisition unit is further configured to acquire a second example set, wherein the second example set includes a plurality of pieces of predetermined second example data; and the prompt information further includes the second example set.

In some possible implementations, the first example set is in front of the second example set in the prompt information.

In some possible implementations, the plurality of pieces of predetermined second example data are used for enumerating a plurality of expressions of a preset field in an example.

In some possible implementations, the determination unit is configured to separately calculate the similarity between each piece of candidate example data in the example library and the target request data; and determine a plurality of pieces of first example data from the example library according to the similarity.

In some possible implementations, the candidate example data includes candidate request example data and candidate request result data, and the candidate request result data corresponds to target result data; and the determination unit is specifically configured to calculate the similarity between the candidate request example data and the target request data.

In some possible implementations, the plurality of pieces of candidate example data include a first candidate data group, and the first candidate example data includes first candidate request example data; and the determination unit is specifically configured to: determine a first vector according to the target request data; determine a second vector according to the first candidate request example data; and determine a similarity between the target request data and the first candidate request example data according to the first vector and the second vector.

In some possible implementations, the determination unit is specifically configured to filter the target request data by a filtering model to obtain a first word set; and determine the first vector according to the first word set.

In some possible implementations, the target request data is request data in a target task scenario, and the first example data includes example data in the target task scenario.

In some possible implementations, the target task scenario is a search task scenario, the first example data includes unstructured data and structured data, the target request data is unstructured data, and the output result is structured data. The sending unit is further configured to send the output result to a search service, and receive a search result returned by the search service.

In a third aspect, the present application provides an electronic device, including:
one or more processors; and
a storage apparatus, storing one or more programs thereon, wherein,
when the one or more programs are executed by the one or more processors, the one or more processors are caused to implement the method in any one of the first aspect.

In a fourth aspect, the present application provides a computer-readable medium, storing a computer program thereon, wherein the program, when executed by a processor, implements the method in any one of the first aspect.

In a fifth aspect, the present application provides a computer program product, wherein the computer program product, when running on a device, causes the device to execute the method in the first aspect.

The present application provides a data processing method, apparatus and system, and a storage medium, which are used for processing request data according to appropriate example data. Specifically, after target request data to be processed is acquired, a first example set may be determined from a preset example library according to the target request data. The first example set includes a plurality of pieces of first example data, and the first example data may provide a reference when the target request data is processed. Next, prompt information may be sent to a target model. The prompt information includes the target request data and the first example set. The target model may learn the first example set and process the target request data after learning the first example set. After completing processing the target request data, the target model may return an output result obtained based on the prompt information. In this way, the first example data for learning is obtained according to the target request data to be processed, so that the similarity between the first example data and the target request data is relatively high. When the target model processes the target request data, the first example data may provide a higher reference value. In this way, the first example set is determined according to the target request data, so that the data used for learning matches the data to be processed, and a more accurate output result can be obtained.

### BRIEF DESCRIPTION OF THE DRAWINGS

To illustrate technical solutions in the embodiments of the present application or in the prior art more clearly, a brief introduction on the drawings which are needed in the description of the embodiments or the prior art is given below. Apparently, the drawings in the description below are merely some of the embodiments of the present application, based on which other drawings may be obtained by those ordinary skilled in the art without any creative effort.

FIG. 1 is a flowchart of a data processing method provided in an embodiment of the present application;

FIG. 2 is a schematic interaction diagram of a data processing method provided in an embodiment of the present application;

FIG. 3 is a schematic diagram of a data query apparatus provided in an embodiment of the present application; and

FIG. 4 is a schematic diagram of an electronic device provided in an embodiment of the present application.

### DETAILED DESCRIPTION OF EMBODIMENTS

Hereinafter, embodiments of the present application will be described in more detail with reference to the drawings. Although some embodiments of the present application have been illustrated in the drawings, it should be understood that the present application may be implemented in various forms and should not be construed as being limited to the embodiments set forth herein; and rather, these embodiments are provided to help understand the present application more thoroughly and completely. It should be understood that the drawings and embodiments of the present application are for exemplary purposes only and are not intended to limit the protection scope of the present application.

It should be understood that, various steps recorded in method embodiments of the present application may be executed in different sequences and/or in parallel. In addition, the method embodiments may include additional steps and/or omit executing the steps shown. The scope of the present application is not limited in this respect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present application are only intended to distinguish different objects, apparatuses, modules or units, and are not intended to limit the sequence or interdependence of functions executed by these apparatuses, modules or units.

It should be noted that, the modifiers such as “one” and “more” mentioned in the present application are intended to be illustrative and not restrictive, and those skilled in the art should understand that the modifiers should be interpreted as “one or more” unless the context clearly indicates otherwise.

The efficiency and accuracy of data processing can be improved by using example data for learning, and there is no need to retrain the data. For example, in natural language processing (NLP), a recognition accuracy may be improved by a contextual learning (CL) technology.

In some task scenarios, information described in a natural language may be converted into information described in a machine language via a language model (LM), for example, a text described in the natural language may be converted into a text described in a JavaScript object notation (JSON) language. In some other application scenarios, a language model may also be caused to execute various other types of tasks.

A prompt is a segment of text described in the natural language, and is used as an important input of the language model to guide the model to generate content.

Contextual learning means that the model solves a new problem by merely including samples and information related to a specific problem in a prompt context, without adjusting the model itself.

To improve the natural language processing capability of the model, contextual learning may be performed by using one piece or more pieces of example data. Specifically, in a task scenario of converting the information described in the natural language into the information described in the machine language, the example data may also be referred to as an example data group, which includes a natural language text and a machine language text of the same content. During the contextual learning, the model may learn an association relationship between the natural language text and the machine language text in the example data. After the contextual learning, the model may convert a natural language text to be processed based on the learned association relationship to determine a corresponding machine language text.

As can be seen from the above description, the example data may provide a reference when the model processes data to be processed. The quality of the example data affects the processing effect of the data. To this end, representative example data may be manually selected by a technician to provide a better reference effect. However, fixed example data may not have a better performance in each task.

An application scenario of natural language processing is still taken as an example for description. Due to the complexity of the natural language, natural language texts of different types of content may correspond to different processing manners. For example, there may be a relatively large difference between a natural language text for triggering the implementation of a certain operation and a natural language text for describing information; there may also be a relatively large difference between a natural language text for triggering a search operation and a natural language text for training a file opening operation; and there may also be a relatively large difference between a natural language text for triggering a schedule search operation and a natural language text for triggering a message search operation. There may also be a difference between example data corresponding to the different natural language texts. Therefore, if fixed example data is used for the contextual learning of the model, the model may not adapt to different types of natural language texts, and thus cannot process the target request data in an appropriate manner.

To solve the problems in the prior art, an embodiment of the present application provides a data processing method, which will be described in detail below with reference to the drawings.

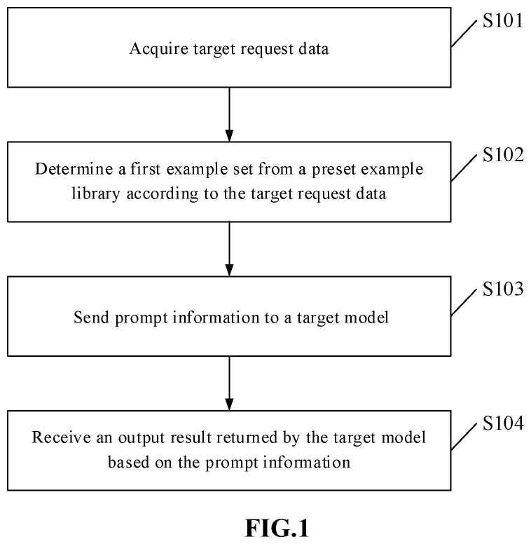

Referring to FIG. 1, FIG. 1 is an information interaction diagram of a data processing method provided in an embodiment of the present application, and the embodiment of the present application may be applied to an application scenario in which example data is used as a reference for processing target request data. The data processing method may be executed by a data processing apparatus, and the data processing apparatus may be implemented by software. Optionally, the apparatus may include a model for processing target request data according to example data, or the apparatus may be associated with the model for processing the target request data according to the example data. Optionally, the model may include, for example, an LM model. In the embodiment of the present application, the model may be referred to as a target model.

Optionally, the data processing apparatus may be integrated in a server or a client of software. The client of the software runs on a terminal device for use, for example, a device such as a mobile phone or a computer. The server of the software may run in a server or a server cluster, and is used for providing a corresponding service for the client of the software. In a case where the data processing apparatus is integrated in the server, the data processing apparatus may communicate with the client to acquire target request data to be processed sent by the client. Optionally, the data processing apparatus may also communicate with the target model to send example data and target request data to the target model. For ease of description, it is taken as an example for description below that the data processing apparatus is integrated in the server.

As shown in FIG. 1, the method includes the following steps:

S101: acquiring target request data.

In the embodiment of the present application, the data processing apparatus may first acquire the target request data. The target request data is related data to be processed. Optionally, in a case where the data processing apparatus runs in the client of the software, the data processing apparatus may acquire target request data input by a user. Or, in a case where the data processing apparatus runs in the server of the software, the user may input the target request data via the client of the software, and the data processing apparatus may acquire, by a network, the target request data sent by the client.

As can be seen from foregoing description, the example data is used for providing a reference in a data processing process. In the embodiment of the present application, to distinguish unprocessed data and processed data, the unprocessed data may be referred to as request data, and the processed data may be referred to as result data. Accordingly, prior to data processing, the data processing apparatus may first acquire the target request data to be processed. In addition, after the target request data is processed, corresponding target result data may be obtained.

S102: determining a first example set from a preset example library according to the target request data.

After the target request data is acquired, the first example set may be determined according to the target request data, the first example set includes at least one piece of first example data. The first example data is example data corresponding to a target request, and is used for playing a reference role during the process of determining target result data corresponding to the target request data.

Accordingly, each piece of first example data may include first request example data and first request result data. The first request example data corresponds to the request data, and the first result example data corresponds to the result data. That is, a correspondence between the first request example data and the first result example data may be used for providing a reference when the target result data corresponding to the target request data is determined. Accordingly, the first example data may also be referred to as a first example data group, which is referred to as an example data group for short.

Optionally, the target request data is request data in a target task scenario, and then the first example data includes example data in the target task scenario. The target task scenario may include a search task scenario. Then, the target request data may be a request instruction input by the user. Optionally, the target request data may be unstructured data, for example, may be a request instruction in a natural language format. Accordingly, the first request example data in the first example data may be unstructured data, and the first result example data in the first example data may be structured data, for example, may be data in a JSON format. The purpose of converting the data into the JSON format is to obtain a search request input into a search service system, and the search service system cannot recognize a natural language instruction and may only recognize an instruction in the JSON format.

Optionally, the first example data group may be a pre-labeled data group. For example, the first request example data and the corresponding first result example data may be manually labeled to obtain the first example data group. Or, a request historically processed by the target model may also be determined as the first request example data, and result data obtained by the processing is determined as the first result example data.

In the embodiment of the present application, the first example set is determined based on the target request data. Optionally, the example library may be established in advance. The example library includes a plurality of pieces of example data. After the target request data is acquired, a plurality of pieces of most matched first example data may be selected from the example library according to the target request data to obtain the first example set. In an actual scenario, the example data in the example library may change or not.

The example data in the example library may also be referred to as candidate example data. Similar to the first example data, each piece of candidate example data may include candidate request example data and candidate result example data. The candidate request example data corresponds to the target request data, and the candidate result example data corresponds to the target result data. Optionally, the candidate example data may also be referred to as a candidate example data group, which is referred to as a candidate example data group for short.

When the first example set is determined, candidate request example data having high similarity with the target request data may be selected from the example library according to the target request data, and then the candidate example data group to which the candidate request example data belongs is determined as the first example data group. Specifically, the similarity between the target request data and each piece of candidate request example data may be calculated first, and then the first example data may be determined according to the similarity.

Hereinafter, a first candidate example data group in the candidate example data group is taken as an example to introduce several possible implementations of determining the similarity between the target request data and the candidate request example data. The first candidate example data group includes first candidate request example data.

As one possible implementation, the similarity between the first candidate request example data and the target request data may be calculated by a model.

As another possible implementation, the similarity between the first candidate request example data and the target request data may be calculated by an editing distance between the first candidate request example data and the target request data. The editing distance between the first candidate request example data and the target request data may include, for example, the number of times for performing editing to adjust the first candidate request example data to the target request data.

As yet another possible implementation, the first candidate request example data and the target request data may be converted into vectors, respectively, to calculate the similarity between the first candidate request example data and the target request data according to the vectors.

Specifically, feature extraction may be performed on the target request data and the first candidate request example data, to determine a vector (hereinafter referred to as a first vector) corresponding to the target request data, and a vector (hereinafter referred to as a second vector) corresponding to the first candidate request example data. After the first vector and the second vector are determined, the similarity between the first candidate request example data and the target request data may be determined based on the first vector and the second vector.

Optionally, the similarity may be determined according to a distance between the first vector and the second vector. Specifically, after the first vector and the second vector are determined, the distance between the first vector and the second vector may be calculated, and then the similarity between the first candidate request example data and the target request data is determined according to the distance between the first vector and the second vector. The smaller the distance between the first vector and the second vector, the smaller the distance in a feature space between the first vector and the second vector is. Then, the closer the target request data to the first candidate request example data, the higher the similarity between the target request data and the first candidate request example data is.

Or, the similarity may be also determined based on a difference value between the first vector and the second vector. Specifically, after the first vector and the second vector are determined, the difference may be taken between the first vector and the second vector to obtain a third vector. Then, the similarity between the first candidate request example data and the target request data may be determined according to the length (or other related parameters) of the third vector. The smaller the length of the third vector, the smaller the difference between the first vector and the second vector is. Then, the closer the target request data to the first candidate request example data, the higher the similarity between the target request data and the first candidate request example data is.

It can be understood that the above three methods for determining the similarity between the target request data and the candidate request example data are merely examples. In an actual application scenario, the similarity between the target request data and the candidate request example data may also be determined in other manners.

In some possible implementations, the target request data may carry more information. Some information may be key information, which needs to be processed in a processing process. Some information may be non-key information, which does not need to be processed in the processing process. Accordingly, since there is no need to process the non-key information, the higher the value of example data having higher relevance with the key information is, and the smaller the value of example data having higher relevance with the non-key information is.

In practical applications, the proportion of the non-key information to the key information in the target request data is not fixed. For example, in some scenarios, there may be more non-key information and less key information in the target request data. In this way, in a case where the similarity between the target request data and the candidate request example data is directly calculated, the similarity may be the similarity between the non-key information in the candidate request example data and the non-key information in the target request data. In this way, the similarity between the candidate request example data and the target request data cannot reflect the similarity between the target request data and the first example request data in terms of key information. Accordingly, due to the lack of the similarity of the key information, a reference value that the first example data determined according to the above method may provide during the process of processing the target request data is relatively small.

To this end, in some possible implementations, filtering may be performed before the similarity is calculated to remove the non-key information from target request information. Specifically, before the similarity between the target request data and the first candidate request example data is calculated, the target request data and the first candidate request example data may be filtered at first to remove the non-key information therein.

Optionally, the target request data and the first candidate request example data may be filtered by a filtering model. The filtering model is used for filtering the request data to remove non-key information from the request data and to retain key information. Optionally, the filtering model may recognize a meaning expressed by the data, to filter out the non-key information having low relevance with the meaning. Optionally, the filtering model may also recognize an intention of the user, to recognize, from the target request data, the key information related to the intention of the user, thereby improving the filtering effect

Optionally, in a case where the target request data includes a natural language text, the filtering model may be a word filtering model, which is used for removing, from the target request data, content unrelated to the intention of the user.

By means of the filtration of the filtering model, a first word set may be obtained according to the target request data, and a second word set may be obtained according to the first candidate request example data. Then, the similarity between the target request data and the first candidate request example data may be determined according to the first word set and the second word set, for example, the first word set may be converted into the first vector, the second word set is converted into the second vector, and then the similarity between the first vector and the second vector is calculated.

After the similarity between the target request data and each piece of candidate request example data is determined, a plurality of pieces of candidate request example data may be selected from the plurality of pieces of candidate request example data in the example library according to the similarity, and a candidate example data group to which the selected candidate request example data belongs is determined as the first example data in the first example set.

For example, in some possible implementations, the first example data group may be determined according to a preset number. The preset number is a preset number of pieces of first example data in the first example set. Specifically, assuming that the preset number is N (N is a positive integer), N pieces of candidate request example data having the highest similarity with the target request data may be selected, and the candidate example data set to which the N pieces of candidate request example data belong is determined as the first example data.

As another example, in some other possible implementations, the first example set may also be determined according to a similarity threshold value. The similarity threshold value is a preset lowest similarity standard. Specifically, after the similarity between each piece of candidate request example data and the target request data is determined, the candidate example data group to which the candidate request example data with a similarity greater than the similarity threshold value belongs may be determined as the first example data.

S103: sending prompt information to the target model.

After the first example set is determined, the server may send the prompt information to the target model. The prompt information may include the target request data and the first example set. The target model may be a model having the capability of determining, according to example information, the result data corresponding to the request data. Optionally, the target model may be a model having a contextual learning capability, and the prompt information may be prompt information.

That is, after determining the first example set corresponding to the target request data, the data processing apparatus may generate the prompt information according to the target request data and the first example set, and then send the prompt information to the target model, so that the target model processes the target request data based on the first example set.

Optionally, the prompt information may be information described based on a JSON language, and is used for indicating a relationship between first target example data and first result example data in the first example data group. According to the prompt information, the target model may learn a correlation rule between the target data and the result data to process the target request data by using the rule to output the result data corresponding to the target request data.

Although there is a certain similarity between the first example data and the target request data in the first example set, the rule between the request data and the result data may not be well reflected merely depending on the first example data. That is, the target model may not accurately learn the rule between the request data and the result data merely depending on the first example data, and thus cannot accurately process the target request data to obtain accurate target result data.

To this end, in some possible implementations, the data processing apparatus may further send a preset second example set to the target model. The second example set includes a plurality of pieces of predetermined second example data. The second example data is used for providing a reference when the target request data is processed.

Optionally, the data processing apparatus may generate the prompt information according to the first example set, the second example set and the target request data, and send the prompt information to the target model.

That is, when the target model processes the target request data, the data used for reference not only includes the first example data determined according to the target request data, but can also include the preset second example data. In this way, even if the first example data cannot play a sufficient reference role, the target model may also determine, according to the second example data, the target result data corresponding to the target request data.

Similar to the first example data, the second example data may include second request example data and second result example data. The second request example data belongs to the request data and corresponds to the target request data, and the second result example data belongs to the result data and corresponds to the target result data.

In the embodiment of the present application, the second example data may be pre-selected data capable of clearly reflecting a rule between original data and the result data. That is, the second example data may be used for enumerating a plurality of expressions of a preset field in an example. For example, assuming that the target model is a model having a natural language processing capability, then the second example data may include a natural language text and a machine language text, which are for a certain topic and are typical. The natural language text corresponds to the second request example data, and the machine language text corresponds to the second result example data.

In this way, in each task, the first example set matched from the example library according to the current request, and a fixed second example set are used. That is, in each task, the first example set is dynamic, and the second example set is fixed.

According to the foregoing description, the target model may need to process different types of request data. Accordingly, the second example data included in the second example set may be different types of data. For example, some second example data may corresponds to a natural language text for triggering a schedule search operation, and some second example data may corresponds to a natural language text for triggering an information search operation. In this way, the target model may learn processing manners for different types of request data according to different second example data, so that the target model can process the different types of request data. In particular, in combination with the first example set, the capability of processing request data of the type of the target request data by the target model may be further enhanced to determine more accurate target result data.

In an actual scenario, the data learning sequence of the target model may affect the learning effect of the target model. For example, for later learned data, the data learning effect of the target model may be better. That is, the later the example data is input into the target model, the greater the reference value that the example data may provide during the process of processing the target request data is.

To this end, in some possible implementations, there may be a sequence between the first example set and the second example set. Specifically, the second example set may be after the first example set. Or, the first example data and the second example data may also be carried in one data set, and the set is equivalent to a union set of the first example set and the second example set. In the set, the first example data is in front of the second example data. In this way, the target model may learn the first example data first and then learn the second example data according to the sequence of the example data in the prompt information.

Or, the server may send sequence information to the target model. The sequence information is used for indicating the sequence of learning the example data by the target model.

S104: receiving an output result returned by the target model based on the prompt information.

After acquiring the prompt information, the target model may perform processing based on the prompt information. Specifically, the target model may perform contextual learning according to the first example set, and process the target request data after the contextual learning to determine the target result data corresponding to the target request data. After determining the target result data, the target model may return the output result to the data processing apparatus. The output result may include the target result data.

In some possible implementations, the target model may not obtain the output result corresponding to the target request data. Accordingly, the target model may also return, to the data processing apparatus, an output result that the target result data cannot be determined.

As can be seen from the foregoing description, the target request data may be request data in a search task scenario. Accordingly, the target result data may be a structured search keyword. In this case, in a case where the output result includes the target result data corresponding to the target request data, after acquiring the output result, the data processing apparatus may send the output result to a search service, so that the search service performs search according to the search keyword. After obtaining a search result, the search service may return the search result to the data processing apparatus.

An embodiment of the present application provides a data processing method, which is used for processing request data according to appropriate example data. Specifically, after target request data to be processed is acquired, a first example set may be determined from a preset example library according to the target request data. The first example set includes a plurality of pieces of first example data, and the first example data may provide a reference when the target request data is processed. Next, prompt information may be sent to a target model. The prompt information includes the target request data and the first example set. The target model may learn the first example set and process the target request data after learning the first example set. After completing processing the target request data, the target model may return an output result obtained based on the prompt information. In this way, the first example data for learning is obtained according to the target request data to be processed, so that the similarity between the first example data and the target request data is relatively high. When the target model processes the target request data, the first example data may provide a higher reference value. In this way, the first example set is determined according to the target request data, so that the data used for learning matches the data to be processed, and a more accurate output result can be obtained.

The data processing method provided in the embodiment of the present application is further described below in combination with an actual application scenario.

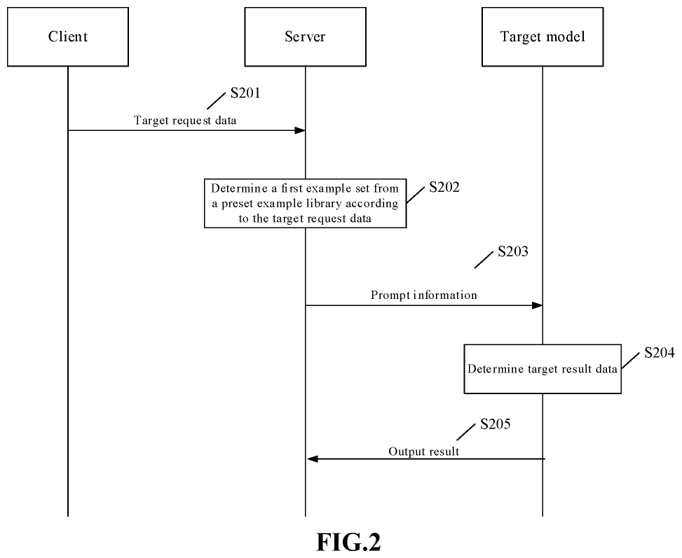

Referring to FIG. 2, FIG. 2 is an information interaction diagram of a data processing method provided in an embodiment of the present application, and the embodiment corresponding to FIG. 2 may be applicable to a process of processing target request data by a target model. The embodiment is specifically applicable to an application scenario in which a user instructs, by a client, a server to execute a corresponding operation. In the implementation shown in FIG. 2, the data processing apparatus is implemented based on the server. The client may be an IM client running on a terminal device of the user, and the server may be a server of IM software, and is used for providing a service for the IM client.

As shown in FIG. 2, the method specifically includes the following steps:

S201: the server acquires target request data sent by the client.

When the user wants to instruct the server to execute a certain operation, the user may send data to the server by the client. Specifically, in a case where the client is an IM client, the user may send data to the server by an IM session. The server may acquire the data sent by the user, and determine the corresponding target request data. Regarding the introduction of the target request data, reference may be made to the foregoing description, and thus details are not described herein again.

Optionally, in some possible implementations, the IM software may provide a corresponding service for the user in the form of an intelligent assistant. The user may send an IM message to the intelligent assistant to instruct an intelligent robot to perform a corresponding operation. Accordingly, the intelligent assistant corresponds to the target model, and is used for providing a service for the user according to the target model.

Specifically, when needing to use a service corresponding to the intelligent assistant, the user may firstly determine an IM session corresponding to the intelligent assistant. In the embodiment of the present application, the IM session corresponding to the intelligent assistant may be referred to as a target IM session, which is used for receiving an IM message sent by the user to perform processing by the target model.

Optionally, the target IM session may be initiated by the user. For example, the user may initiate the target TI session by a contact list or service number list in the IM client. Specifically, after starting a corresponding function, the user may add, in a contact list of the user, an IM contact corresponding to the intelligent assistant. After adding the contact, the user may initiate the target IM session by the IM contact. Or, after the user starts the corresponding function, the target IM session is added into an IM session list of the user. Accordingly, the user may find the target IM session in a manner of slide browsing or search to send the target IM message.

By the target IM session, the user may send the IM message to the server. The IM message includes target request data to be processed, which may be referred to as the target IM message. Optionally, a target IM message box may include an IM message in a text format, and may also include an IM message in an audio format. The IM message in the text format may be input by the user via a text input box corresponding to the target IM session, or obtained by converting an audio message input by the user into characters. The IM message in the audio format may be input by the user via a pickup device such as a microphone.

After the target IM message input by the user is acquired, the target IM message input by the user may be analyzed to determine the corresponding target request data. Specifically, data extraction may be performed on the target IM message to determine target request data in the text format. Or, in a case where the target IM message is the TN message in the audio format, after acquiring the target IM message, the server may convert the target IM message to obtain the target request data in the text format.

S202: the server determines a first example set from a preset example library according to the target request data.

After acquiring the target request data, the server may determine a plurality of first example sets according to the target request data. Regarding the specific process of determining the first example set, reference may be made to the description of corresponding parts in FIG. 1, and thus details are not described herein again.

As can be seen from the foregoing description, the first example data may be obtained based on a vector corresponding to the target request data. Accordingly, in some possible implementations, the example library may include a pre-constructed vector database. The vector database includes a plurality of pieces of candidate example data, and a vector corresponding to candidate request example data in each piece of candidate example data. Accordingly, the server may determine the first example set by the vector database.

Specifically, after acquiring the target request data, the server may send, to the vector database, the target request data or the vector corresponding to the target request data. The vector database may determine a plurality of pieces of candidate request example data according to the vectorized target request data, so as to determine a plurality of pieces of first example data to obtain the first example set.

S203: the server sends prompt information to the target model.

After determining the first example set, the server may send the prompt information to the target model. Regarding the introduction of the prompt information, reference may be made to the description of corresponding parts in FIG. 1, and thus details are not described herein again.

S204: the target model determines target result data according to the prompt information.

After acquiring the prompt information, the target model may determine the target result data according to the prompt information. Specifically, in a case where the target model is a model having a semantic analysis capability (for example, LM), the target result data may be a machine language text, and the content described by the target result data matches the content described by the target request data.

Optionally, the target model may load example data (for example, the first example data and/or the second example data) in the prompt information into context information, and determine a rule between the request data and the result data in a contextual learning manner, to determine, according to the corresponding rule, the target result data corresponding to the target request data.

For example, it is assumed that the target request data is a natural language text of a type A. In this case, the first request example data in the first example data may be a natural language text of the type A, and the first result example data in the first example data may be a machine language text of the type A. In this way, according to the first example data, the target model may determine an association relationship between the natural language text of the type A and the machine language text of the type A, to analyze the target request data by using the association relationship to determine the target result data corresponding to the target request data.

As can be seen from the foregoing description, the prompt information may further include a second example set. In a case where the prompt information includes the second example set, the target model may determine the target result data in combination with the first example set and the second example set. Specifically, the target model may perform contextual learning on the first example data and the second example data according to the sequence of the first example set and the second example set in the prompt information to determine the target result data.

S205: the target model sends an output result to the server.

After obtaining the target result data corresponding to the target request data, the target model may send the output result to the server. The output result may include the target result data.

For example, in some possible implementations, the target request data may be indication information sent by the user. The target model is used for determining an intention of the user according to the indication information sent by the user, and sending the intention of the user to the server in the form of a machine language text. The server may invoke, according to the intention of the user, a corresponding virtual tool to execute a corresponding operation to meet the intention of the user.

Description will be given below in combination with an actual application scenario.

For example, in a case where the user wants to reserve a schedule, the user may send an IM message “Help me schedule a meeting at 10 o'clock in tomorrow morning” on the IM client via the target IM session. The IM server may acquire the IM message, and determine a corresponding first example set according to the IM message. Optionally, first request example data in first example data may include a natural language text for triggering a schedule reservation operation, for example, may include keywords such as “conference”, “schedule”, and “reserve”.

After determining the first example set, the server may generate corresponding prompt information according to the first example set and the natural language text “Help me schedule a meeting at 10 o'clock in tomorrow morning”, and send the prompt information to the target model.

The target model may perform contextual learning according to the first example set in the prompt information to learn an association relationship between the natural language text for triggering the schedule reservation operation and a machine language text, to convert the natural language text “Help me schedule a meeting at 10 o'clock in tomorrow morning” into the corresponding machine language text (i.e., target result data) and to return the same to the server. After acquiring the target result data sent by the target model, the server may invoke an interface of a schedule virtual tool to reserve a meeting at 10 o'clock in tomorrow morning for the user.

As another example, in a case where the user wants to search for some information, the user may send an IM message “Help me query information about content A” on the IM client via the target IM session. The IM server may acquire the IM message, and determine a corresponding first example set according to the IM message. Optionally, the first request example data in the first example data may include a natural language text for triggering a content search operation, for example, may include keywords such as “query” and “content A”.

After determining the first example set, the server may generate corresponding prompt information according to the first example set and the natural language text “Help me query information about content A”, and send the prompt information to the target model.

The target model may perform contextual learning according to the first example set in the prompt information to learn an association relationship between the natural language text for triggering the content search operation and a machine language text, to convert the natural language text “Help me query information about content A” into the corresponding machine language text (i.e., the target result data) and to return the same to the server. After acquiring the target result data sent by the target model, the server may invoke an interface of a search engine to search for, for the user, information related to the content A, and display the information to the user via the client.

In this way, an instruction of the user may be processed by the target model, thereby improving user experience. Moreover, first example information used during the process of processing the instruction of the user is determined according to the instruction (i.e., first request information) sent by the user, so that an accuracy of determining the intention of the user by the target model is improved.

Based on the data processing method provided in the above method embodiments, an embodiment of the present application further provides a data processing apparatus, and the data processing apparatus will be described below with reference to the drawings.

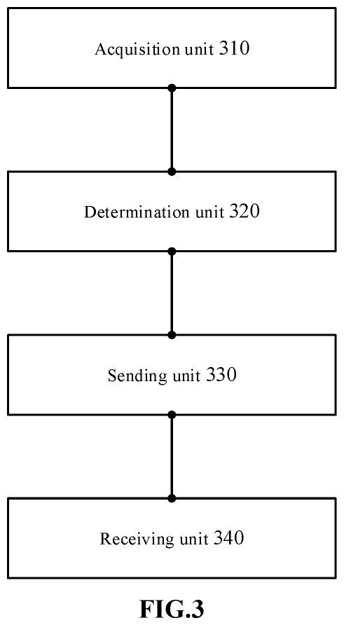

Referring to FIG. 3, it is a schematic structural diagram of a data processing apparatus provided in an embodiment of the present application. As shown in FIG. 3, the data processing apparatus 300 includes:
an acquisition unit 310, configured to acquire target request data;
a determination unit 320, configured to determine a first example set from a preset example library according to the target request data, wherein the first example set includes a plurality of pieces of first example data;
a sending unit 330, configured to send prompt information to a target model, wherein the prompt information includes the target request data and the first example set; and
a receiving unit 340, configured to receive an output result returned by the target model based on the prompt information.

Optionally, the acquisition unit 310 and the receiving unit 340 may be the same unit, or may be different units.

In some possible implementations, the acquisition unit 310 is further configured to acquire a second example set, wherein the second example set includes a plurality of pieces of predetermined second example data; and the prompt information further includes the second example set.

In some possible implementations, the first example set is in front of the second example set in the prompt information.

In some possible implementations, the plurality of pieces of predetermined second example data are used for enumerating a plurality of expressions of a preset field in an example.

In some possible implementations, the determination unit 320 is configured to separately calculate a similarity between each piece of candidate example data in the example library and the target request data; and determine a plurality of pieces of first example data from the example library according to the similarity.

In some possible implementations, the candidate example data includes candidate request example data and candidate request result data, and the candidate request result data corresponds to target result data; and the determination unit 320 is specifically configured to calculate a similarity between the candidate request example data and the target request data.

In some possible implementations, the plurality of pieces of candidate example data include a first candidate data group, and the first candidate example data includes first candidate request example data; and the determination unit 320 is specifically configured to: determine a first vector according to the target request data; determine a second vector according to the first candidate request example data; and determine a similarity between the target request data and the first candidate request example data according to the first vector and the second vector.

In some possible implementations, the determination unit 320 is specifically configured to filter the target request data by a filtering model to obtain a first word set; and determine the first vector according to the first word set.

In some possible implementations, the target request data is request data in a target task scenario, and the first example data includes example data in the target task scenario.

In some possible implementations, the target task scenario is a search task scenario, the first example data includes unstructured data and structured data, the target request data is unstructured data, and the output result is structured data. The sending unit 330 is further configured to send the output result to a search service, and receive a search result returned by the search service.

Based on the data processing method provided in the above method embodiments, the present application further provides an electronic device, including: one or more processors; and a storage apparatus, storing one or more programs thereon, wherein when the one or more programs are executed by the one or more processors, the one or more processors are caused to implement the data processing method in any one of the above embodiments.

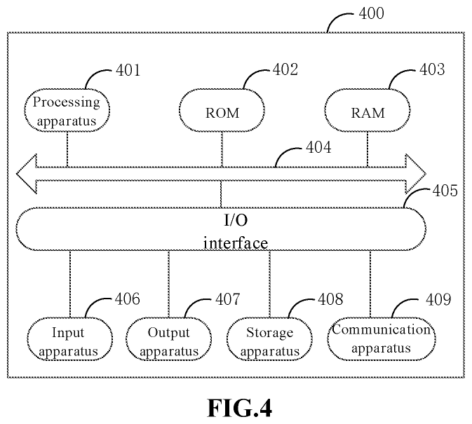

Referring to FIG. 4 below, it illustrates a structural schematic diagram of an electronic device 400 suitable for implementing an embodiment of the present application. The terminal device 400 in the embodiment of the present application may include, but is not limited to, mobile terminals such as mobile phones, notebook computers, digital broadcast receivers, PDAs (Personal Digital Assistants), PADs (Portable Android Devices), PMPs (Portable Multimedia Players), in-vehicle terminals (e.g., in-vehicle navigation terminals), and the like, and fixed terminals such as digital TVs (Televisions), desktop computers, etc. The electronic device shown in FIG. 4 is merely an example and should not bring any limitation to the functions and use ranges of the embodiments of the present application.

As shown in FIG. 4, the electronic device 400 may include a processing apparatus (e.g., a central processing unit, a graphics processing unit, or the like) 401, which may execute various suitable actions and processes in accordance with a program stored in a read-only memory (ROM) 402 or a program loaded from a storage apparatus 408 into a random access memory (RAM) 403. In the RAM 403, various programs and data needed by the operations of the electronic device 400 are also stored. The processing apparatus 401, the ROM 402 and the RAM 403 are connected to each other via a bus 404. An input/output (I/O) interface 405 is also connected to the bus 404.

In general, the following apparatuses may be connected to the I/O interface 405: an input apparatus 406, including, for example, a touch screen, a touch pad, a keyboard, a mouse, a camera, a microphone, an accelerometer, a gyroscope, and the like; an output apparatus 407, including, for example, a liquid crystal display (LCD), a speaker, a vibrator, and the like; a storage apparatus 408, including, for example, a magnetic tape, a hard disk, and the like; and a communication apparatus 409. The communication apparatus 409 may allow the electronic device 400 to communicate in a wireless or wired manner with other devices to exchange data. Although FIG. 4 illustrates the electronic device 400 having various apparatuses, it should be understood that not all illustrated apparatuses are required to be implemented or provided. More or fewer apparatuses may alternatively be implemented or provided.

In particular, according to the embodiments of the present application, the processes described above with reference to the flowcharts may be implemented as computer software programs. For example, the embodiments of the present application include a computer program product, which includes a computer program carried on a non-transitory computer-readable medium, and the computer program contains program codes for executing the method illustrated in the flowcharts. In such embodiments, the computer program may be downloaded and installed from a network via the communication apparatus 409, or installed from the storage apparatus 408, or installed from the ROM 402. When the computer program is executed by the processing apparatus 401, the above functions defined in the method of the embodiments of the present application are executed.

The electronic device provided in the embodiment of the present application and the data processing method provided in the above embodiments belong to the same inventive concept, technical details that not described in detail in the present embodiment may refer to the above embodiments, and the present embodiment has the same effects as the above embodiments.

Based on the data processing method provided in the above method embodiments, an embodiment of the present application provides a computer storage medium, storing a computer program thereon, wherein the program, when executed by a processor, implements the data processing method provided in any one of the above embodiments.

It should be noted that, the computer-readable medium described above in the present application may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination of the above. In the present application, the computer-readable storage medium may be any tangible medium that contains or stores a program that may be used by or in combination with an instruction execution system, apparatus or device. In the present application, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transmit the program for use by or in combination with the instruction execution system, apparatus or device. Program codes contained on the computer-readable medium may be transmitted with any suitable medium, including, but not limited to: an electrical wire, an optical cable, RF (Radio Frequency), and the like, or any suitable combination thereof.

In some embodiments, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (“LAN”), a wide area network (“WAN”), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when executed by the electronic device, cause the electronic device to execute the above data processing method.

Computer program codes for executing the operations of the present application may be written in one or more programming languages or combinations thereof. The programming languages include, but are not limited to, object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including a local area network (LAN) or a wide area network (WAN), or it may be connected to an external computer (e.g., through the Internet using an Internet service provider).

The flowcharts and block diagrams in the drawings illustrate system architectures, functions and operations of possible implementations of systems, methods and computer program products according to various embodiments of the present application. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially in parallel, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present application may be implemented in a software or hardware manner. The names of the units/modules do not constitute limitations of the units themselves in a certain case. For example, a voice data collection module may also be described as “data collection module”.

The functions described herein above may be executed, at least in part, by one or more hardware logical components. For example, without limitation, example types of the hardware logical components that may be used include: a field programmable gate data group (FPGA), an application specific integrated circuit (ASIC), an application specific standard product (ASSP), a system on chip (SOC), a complex programmable logic device (CPLD), and so on.

In the context of the present application, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any suitable combination thereof.

It should be noted that the embodiments in the present specification are described in a progressive manner, each embodiment focuses on differences from other embodiments, and the same or similar parts between the embodiments refer to each other. For the system or apparatus disclosed in the embodiments, since it corresponds to the method disclosed in the embodiments, the description thereof is relatively simple, and regarding related parts, reference may be made to the description of the method.

It should be understood that in the present application, “at least one (item)” means one or more, and “a plurality of” means two or more. For example, “And/or” is used for describing an association relationship of associated objects, and indicates that there may be three relationships. For example, “A and/or B” may indicate three cases, that is, only A exists, only B exists, and both A and B exist at the same time, wherein A and B may be singular or plural. The character “/” generally indicates an “or” relationship between front and back associated objects. The term “at least one (item) of the following” or similar expressions refer to any combination of these items, including any combination of a single item (piece) or a plurality of items (pieces). For example, at least one of a, b or c may indicate: a, b, c, “a and b”, “a and c”, “b and c”, or “a and b and c”, wherein a, b and c may be singular or plural.

It should also be noted that herein, relational terms, such as first, second and the like, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. In a case where there are no more restrictions, the element defined by the sentence “including a . . . ” does not exclude the existence of other identical elements in the process, the method, the article or the device that includes the element.

The above descriptions of the disclosed embodiments enable those skilled in the art to implement or use the present application. Various modifications to these embodiments will be apparent to those skilled in the art, and the general principles defined herein may be implemented in other embodiments without departing from the spirit or scope of the present application. Thus, the present application will not be limited to the embodiments shown herein, but is to be accorded with the widest scope consistent with the principles and novel features disclosed herein.

I/We claim:

1. A data processing method, comprising:
acquiring target request data;
determining a first example set from a preset example library according to the target request data, wherein the first example set comprises a plurality of pieces of first example data;
sending prompt information to a target model, wherein the prompt information comprises the target request data and the first example set; and
receiving an output result returned by the target model based on the prompt information.

2. The method according to claim 1, further comprising:
acquiring a second example set, wherein the second example set comprises a plurality of pieces of predetermined second example data;
wherein the prompt information further comprises the second example set.

3. The method according to claim 2, wherein,
the first example set is in front of the second example set in the prompt information.

4. The method according to claim 2, wherein the plurality of pieces of predetermined second example data are used for enumerating a plurality of expressions of a preset field in an example.

5. The method according to claim 1, wherein determining the first example set according to the target request data comprises:
separately calculating a similarity between each piece of candidate example data in the example library and the target request data; and
determining a plurality of pieces of first example data from the example library according to the similarity.

6. The method according to claim 5, wherein the candidate example data comprises candidate request example data and candidate request result data, and the candidate request result data corresponds to target result data; and
wherein separately calculating the similarity between each piece of candidate example data and the target request data comprises:
calculating a similarity between the candidate request example data and the target request data.

7. The method according to claim 6, wherein the plurality of pieces of candidate example data comprise first candidate example data, the first candidate example data comprises first candidate request example data, and calculating the similarity between the candidate request example data and the target request data comprises:
determining a first vector according to the target request data;
determining a second vector according to the first candidate request example data; and
determining a similarity between the target request data and the first candidate request example data according to the first vector and the second vector.

8. The method according to claim 6, wherein determining the first vector according to the target request data comprises:
filtering the target request data by a filtering model to obtain a first word set; and
determining the first vector according to the first word set.

9. The method according to claim 1, wherein the target request data is request data in a target task scenario, and the first example data comprises example data in the target task scenario.

10. The method according to claim 9, wherein the target task scenario is a search task scenario, the first example data comprises unstructured data and structured data, the target request data is unstructured data, and the output result is structured data; and
wherein the method further comprises:
sending the output result to a search service, and receiving a search result returned by the search service.

11. An electronic device, comprising:
one or more processors; and
a storage apparatus, storing one or more programs thereon, wherein,
when the one or more programs are executed by the one or more processors, the one or more processors are caused to:
acquire target request data;
determine a first example set from a preset example library according to the target request data, wherein the first example set comprises a plurality of pieces of first example data;
send prompt information to a target model, wherein the prompt information comprises the target request data and the first example set; and
receive an output result returned by the target model based on the prompt information.

12. The electronic device according to claim 11, wherein the one or more processors are further caused to:
acquire a second example set, wherein the second example set comprises a plurality of pieces of predetermined second example data;
wherein the prompt information further comprises the second example set.

13. The electronic device according to claim 12, wherein,
the first example set is in front of the second example set in the prompt information.

14. The electronic device according to claim 12, wherein the plurality of pieces of predetermined second example data are used for enumerating a plurality of expressions of a preset field in an example.

15. The electronic device according to claim 11, wherein the one or more processors are caused to determine the first example set according to the target request data by being caused to:
separately calculate a similarity between each piece of candidate example data in the example library and the target request data; and
determine a plurality of pieces of first example data from the example library according to the similarity.

16. The electronic device according to claim 15, wherein the candidate example data comprises candidate request example data and candidate request result data, and the candidate request result data corresponds to target result data; and
wherein the one or more processors are caused to separately calculate the similarity between each piece of candidate example data and the target request data by being caused to:
calculate a similarity between the candidate request example data and the target request data.

17. The electronic device according to claim 16, wherein the plurality of pieces of candidate example data comprise first candidate example data, the first candidate example data comprises first candidate request example data, and the one or more processors are caused to calculate the similarity between the candidate request example data and the target request data by being caused to:
determine a first vector according to the target request data;
determine a second vector according to the first candidate request example data; and
determine a similarity between the target request data and the first candidate request example data according to the first vector and the second vector.

18. The electronic device according to claim 16, wherein the one or more processors are caused to determine the first vector according to the target request data by being caused to:
filter the target request data by a filtering model to obtain a first word set; and
determine the first vector according to the first word set.

19. The electronic device according to claim 11, wherein the target request data is request data in a target task scenario, and the first example data comprises example data in the target task scenario.

20. A non-transitory computer-readable medium, storing a computer program thereon, wherein the program, when executed by a processor, implements:
acquiring target request data;
determining a first example set from a preset example library according to the target request data, wherein the first example set comprises a plurality of pieces of first example data;
sending prompt information to a target model, wherein the prompt information comprises the target request data and the first example set; and
receiving an output result returned by the target model based on the prompt information.
